(19) United States
(12) Patent Application Publication
(10) Pub. No.: US 2026/0025276 A1
(43) Pub. Date: Jan. 22, 2026

(54) METHODS, DEVICES AND SYSTEMS HAVING PER-DEVICE CREDENTIAL FOR DIFFERENTIATED ACCESS AND/OR SERVICES

(71) Applicant: Cypress Semiconductor Corporation, San Jose, CA (US)

(72) Inventor: Hui Luo, Marlboro, NJ (US)

(73) Assignee: Cypress Semiconductor Corporation, San Jose, CA (US)

(21) Appl. No.: 19/331,048

(22) Filed: Sep. 17, 2025

Related U.S. Application Data
(60) Provisional application No. 63/674,097, filed on Jul. 22, 2024.
(60) Provisional application No. 63/700,951, filed on Sep. 30, 2024.
(60) Provisional application No. 63/727,499, filed on Dec. 3, 2024.
(60) Provisional application No. 63/743,904, filed on Jan. 10, 2025.

(51) Int. Cl. H04L 9/32

(52) U.S. Cl. CPC H04L 9/3236; H04L 9/3231; H04L 9/3247

(57) ABSTRACT

A method can include, by operation of a first wireless device, storing a per-device credential (PDC). Authentication data frames can be exchanged with an access point device (AP) to generate at least one encryption key. An expected fingerprint can be compared to a system fingerprint. A hash of the PDC can be transmitted in an association request frame. The expected fingerprint can be a result of a predetermined hashing operation executed on at least a portion of a service set identifier of the AP and a public key corresponding to the AP. Corresponding devices and systems are also disclosed.

### CROSS-REFERENCE TO RELATED APPLICATIONS

The present application claims the priority and benefit of U.S. Patent Applications Nos. 63/727,499 filed on Dec. 3, 2024, 63/700,951 filed on Sep. 30, 2024, 63/674,097 filed on Jul. 22, 2024, and 63/743,904 filed on Jan. 10, 2025, the contents all of which are incorporated by reference herein in their entirety.

### TECHNICAL FIELD

The present disclosure relates generally to wireless systems, and more particularly to wireless systems that provide per-device credentials for differentiated user access and/or services.

### BACKGROUND

Conventional wireless networking for personal use (e.g., Wi-Fi Personal Mode, relying on WPA2 or WPA3) can rely on a single password for user authentication, and thus does not provide for differentiated user access control and/or services.

The use of a password identifier in a simultaneous access of equals (SAE) type exchange as a per-device credential has been proposed. However, such password identifiers are passed in clear text, and so can suffer from lack of privacy.

A conventional per-device credential method that can provide for user privacy is Wi-Fi Enterprise Mode, based on Extensible Authentication Protocol-Transport Layer Security (EAP-TLS) v1.3. In such a method, a user identifier or equivalent value can be encrypted by a public key. However, such operations can require an Authentication, Authorization, and Accounting (AAA) type server. This can result in high costs. Further, configuring public keys can be more complex and involved than configuring a per-device password or credential.

It would be desirable to arrive at some way of providing per-device credentialing that provides for user privacy, while not incurring high costs and/or undue complexity that exists in conventional approaches.

### SUMMARY

A method can include, by operation of a first wireless device, storing a PDC that distinguishes the wireless device from other wireless devices, in response to receiving an information data frame from an AP that indicates support for PDC authentication, transmitting at least one authentication data frame to the AP that includes at least a first element, receiving at least a one authentication data frame from the AP that includes at least a second element, generating at least one encryption key with at least the first and second elements, comparing an expected fingerprint to a system fingerprint, executing a hashing operation to generate a hash of the PDC, and transmitting an association request frame that includes at least the hash of the PDC encrypted with the at least one encryption key. The expected fingerprint can be a result of a predetermined hashing operation executed on at least a portion of a SSID of the AP and a public key corresponding to the AP.

### BRIEF DESCRIPTION OF DRAWINGS

FIG. 1 is a diagram showing a system and operations according to an embodiment.

FIG. 2 is a diagram showing a system and operations according to another embodiment.

FIG. 3 is a diagram showing a system and operations according to a further embodiment.

FIG. 4 is a signaling diagram showing a system and operations according to another embodiment.

FIGS. 5-0 and 5-1 show beacon and/or probe response data frames according to embodiments.

FIGS. 6-0 and 6-1 show authentication request data frames according to embodiments.

FIGS. 7-0 and 7-1 show authentication response data frames according to embodiments.

FIGS. 8-0 and 8-1 show association request data frames according to embodiments.

FIG. 9 is a block diagram of a wireless device according to an embodiment.

FIG. 10 is a block diagram of a station device (STA) according to an embodiment.

FIG. 11 is a block diagram of a wireless device according to another embodiment.

FIG. 12 is a block diagram of an access point device (AP) according to an embodiment.

FIG. 13 is a flow diagram of a method executable by a STA according to an embodiment.

FIG. 14 is a flow diagram of a method executable by an AP according to an embodiment.

FIG. 15 is a diagram of integrated circuit devices according to embodiments.

FIG. 16 is a diagram of an automobile system according to an embodiment.

FIG. 17 is a diagram of a system having Internet-of-Things devices according to an embodiment.

### DETAILED DESCRIPTION

According to embodiments, a wireless device (e.g., STA) can have a secret per-device credential (PDC) to distinguish it from other wireless devices. A wireless device can exchange element values with an access point device (AP) device, and using such elements generate one or more mutual passwords. A wireless device can establish the trustworthiness of an AP with a public key “fingerprint”. A fingerprint can be the result of a hash operation that includes an AP public key (AP_K) and at least a portion of a service set identifier (SSID) as inputs. Once authenticated with an AP, a STA can perform a predetermined hash operation on its PDC (Hash(PDC)), encrypt it with a mutual key, and include it in an association request transmitted to an AP. An AP can decrypt an association request to determine the presence and/or value of Hash(PDC) value. If a Hash(PDC) value is known by the AP (e.g., stored in an access control list, ACL), the AP can proceed with an association that can provide per-device access and/or services based on a Hash(PDC) value.

In some embodiments, a PDC can be a device specific value (e.g., a value determined by a manufacturer or user) and an AP SSID can include a device specific value separated from the fingerprint by one or more separation characters.

In some embodiments, a PDC can include a device specific value separated from the fingerprint by one or more separation characters and an AP SSID may not include the fingerprint.

In some embodiments, an AP can transmit a beacon data frame and/or provide a probe response data frame that includes a portion (e.g., Robust Security Network Extension, RSNXE, element) that indicates support of a PDC.

In some embodiments, an AP can receive or be in possession of, a digital certificate for a wireless device. If a corresponding public key (STA_K) is known by the AP, the AP validate a digital signature from the wireless device using STA_K.

In some embodiments, an exchange of elements can include a simultaneous authentication of equals (SAE) type exchange, where a wireless device can provide a first scalar (S1) and first element (E1) to an AP, and an AP can provide a second scalar (S2) and second element (E2) to the wireless device. E1 and E2 can be generated using the fingerprint.

In some embodiments, an exchange of elements can include a Elliptic-Curve Diffie-Hillman (ECDH) protocol, where a wireless device can provide a first public value to an AP, and an AP can provide a second public value to the wireless device. The first and second public values can be used to generate one or more mutual encryption keys.

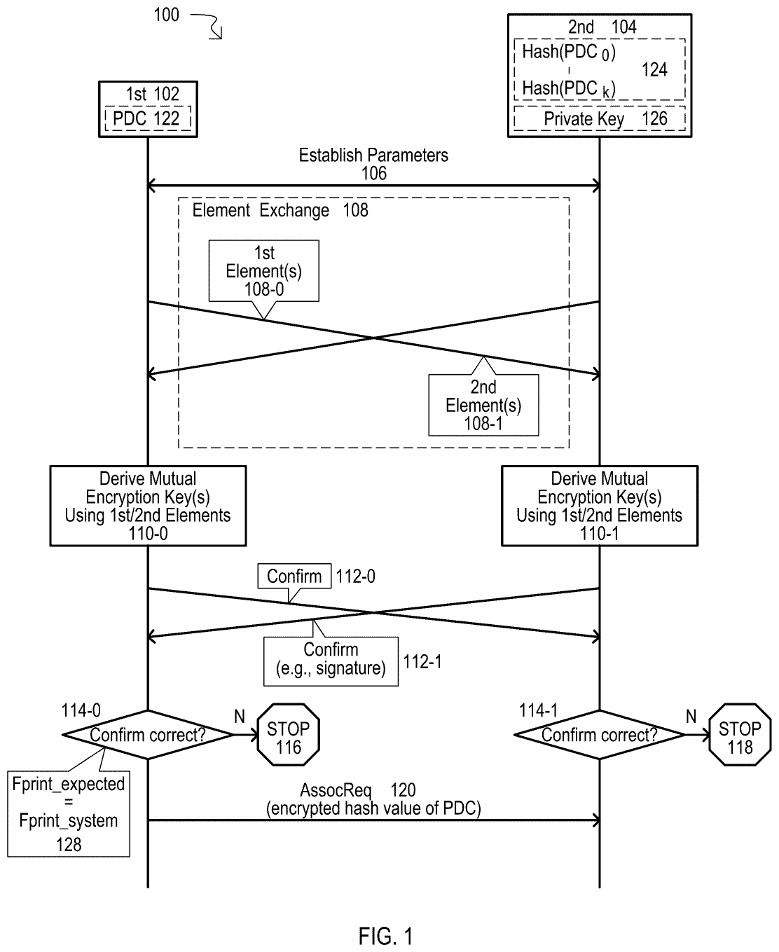

FIG. 1 is a signaling diagram showing a system 100 and operations according to an embodiment. A system 100 can include a first wireless device 102 and a second wireless device 104. A first wireless device 102 can store its own PDC 122. A second wireless device 104 can store a list 124 that includes hashes of PDC values, which may or may not include a hash of the PDC 122 corresponding to first wireless device 102. A list 124 can be used by a second wireless device 104 to differentiate access and/or features of a connection. A second wireless device 104 can also store, and keep a secret, a private key 128 having a public key analog.

Operations can include establishing parameters 106. Such an action can include a first device 102 receiving parameters from a second device 104, which may or may not include a first device 102 requesting such parameters. Parameters can include information on how authentication operations can occur, including but not limited to encryption related data (e.g., supported cipher suites).

First and second wireless devices (102 and 104) can exchange elements 108. Such an action can include a first wireless device 102 deriving a first element 108-0, and wirelessly transmitting it to second wireless device 104. A second wireless device 104 can derive a second element 108-1, and wirelessly transmit it to a first wireless device 102. First device 102 can derive one or more mutual encryption keys using first and second elements 110-0. Similarly, second device 104 can derive the same mutual encryption key(s) using first and second elements 110-1.

First and second wireless devices (102 and 104) can exchange confirmation values that can be used verify successful generation of mutual encryption key(s). Such an action can include a first wireless device 102 generating a first confirmation value 112-0 can and wirelessly transmitting it to second wireless device 104. A second wireless device 104 can generate a second confirmation value 112-1 and transmit it to first wireless device 102. In some embodiments, a second confirmation value 112-1 can include a digital signature signed using a private key 126. Confirmation values (112-0/1) can enable first wireless device 102 to confirm second wireless device 104 has the appropriate encryption employed, and vice versa.

A first wireless device 102 can determine if a received confirmation value is correct 114-0. Such an action can include a first wireless device 102 determining if a second device is trustworthy through a “Fingerprint” (Fprint). A Fingerprint 126 can be a value generated by one or more operations (e.g., hashing) on input values including a public key corresponding to private key 126 and a network identifier, such as an SSID. A system fingerprint (Fprint_System) can already be present in a system (e.g., part of a PDC and/or part of a network identifier). A wireless device 102 can compute the Fingerprint itself (Fprint_Expected) and compare it to Fprint_System 128. If such values are the same, a first wireless device can trust the public key of the second wireless device. A first wireless device 102 can decrypt confirm message 212-1 with a mutual encryption key and/or using a public key corresponding to private key 126 to validate a digital signature included in second confirmation 112-1. If a first wireless device 104 finds a second wireless device confirmation is not correct (N from 114-0), communications with second wireless device can end 116.

If a first wireless device 104 finds a second wireless device confirmation is correct (Y from 114-0), a first wireless device 102 can send a message 120 that includes a hash of its PDC 122, encrypted with a mutual encryption key.

In this way, a wireless device, using an encryption key generated with public key data of another device, and encrypt and transmit a representation (e.g., hash) of a PDC to another device, to variations in access and/or services based on the PDC.

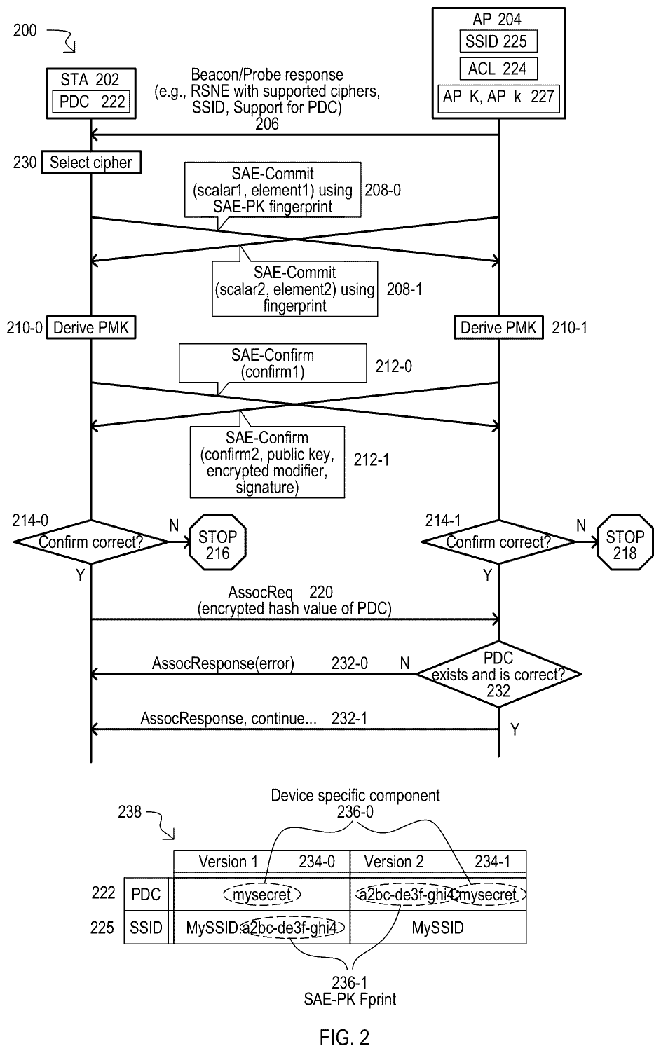

FIG. 2 is a signaling diagram of a system 200 and operations according to additional embodiments. A system 200 can include wireless devices compatible with one or more IEEE 802.11 wireless standards, including a STA 202 and an AP 204. An AP 204 can control a basic service set (BSS) including differentiating access and/or services based on PDCs of STAs. A STA 202 can store its own PDC 222 that can be used to differentiate it from other STAs accessing a same BSS, and take various forms as will be described in more detail below. An AP 204 can store an SSID 225 and include a data structure that can be accessed to differentiate access/services for STAs, which can take the form of an access control list (ACL) 224 in the embodiment shown. An SSID 225 can take various forms as will be described below. AP 204 can operate according to a public key (AP_K) and corresponding private key (AP_k) 227. Private key AP_k can be stored securely. Public key AP_K can be made available

A system 200 can include a STA and AP (202 and 204) calculating a “Fingerprint”. A Fingerprint can be a value generated by a predetermined operation (e.g., hash) executed on a number of input values, including but not limited to all or a portion of an SSID and an AP_K. In some embodiments, an SSID 225 can include a Fingerprint, in which case a Fingerprint can be generated by portions of an SSID that exclude such a Fingerprint. In some embodiments, a Fingerprint can be generated according to the following relationship set forth in the WPA3™ Specification, Version 3.1.

$$Fingerprint = L ( Hash ( {SSID}^{*} ‖ M ‖ AP\_K ) , 0 , {8}^{*} Sec + {19}^{*} λ / 4 - 5 ) ,$$

L(S, F, N) can be a function that extracts bits F to F+N−1 of the bit string S starting from the left. Hash( ) can be a hash algorithm indicated by SAE operations in IEEE 802.11 wireless standards, including any of SHA-256, SHA-384 or SHA-512. As will be described in more detail herein, the SSID* used in the generation of the Fingerprint can be a full SSID for an AP (if a Fingerprint is not included in the SSID), or a non-Fingerprint portion of an SSID for an AP (if a Fingerprint is included in an SSID). M can be a modifier value found setting M to a random unsigned integer, and incrementing by one until the first Sec octets of the Fingerprint are zero. Sec can be a hash extension security parameter equal to 3 or 5. A can be selected such that A=4*n, where n is an integer greater than 3, and 8*Sec+19*A/4-5 is less-than-or-equal to the output length of Hash( ).

Referring still to FIG. 2, in operation, a STA 202 can receive an information data frame 206 from AP 204 that can provide information for joining (e.g., authenticating and associating) with a network. Such an information data frame 206 can include but is not limited to, a beacon data frame and/or probe response data frame. Information data frame 206 can have various fields, including but not limited to a Robust Security Network Element (RSNE) that can indicate supported ciphers, an SSID field, and one or more other fields (e.g., RSNXE) that can indicate support for differentiating access and/or services based on a STA's PDC. Upon receiving information data frame 206, STA can select a cipher suite 230 for use in authentication/association operations.

The operations of FIG. 2 show an SAE-PK type exchange, however, with elements being generated using a Fingerprint. A STA 202 can generate and transmit a SAE-Commit message 208-0, which can include a first scalar (scalar1) and first element (element1) generated using a Fingerprint. Similarly, AP 204 can generate and transmit a SAE-Commit message 208-1, which can include a second scalar (scalar2) and second element (element2) generated using a Fingerprint. In some embodiments, element1 and element2 can be generated using seed value generated by hashing an input value that includes a Fingerprint. In a particular embodiment, element1 and element2 can be generated using a pwd-seed value according to the following relationship.

$$pwd - seed = HKDF - Extract ( SSID ) ,$$

HKDF-Extract can include the hash algorithms noted herein. In some embodiments, SSID can include a Fingerprint while a PDC does not (e.g., MySSID:a2bc-de3f-ghi4). In other embodiments, SSID does not include a Fingerprint while a PDC does (e.g., a2bc-de3f-ghi4:mysecret). A pwd-seed value can then be used in an expansion operation to eventually arrive at an element value (e.g., element1 or element2).

Once commit messages 208-0/1 have been exchanged, a STA 202 and AP 204 can generate encryption keys 210-0/1 using exchanged SAE factors (scalar1, element1, scalar2, element2). In the embodiment shown, a STA 202 and AP 204 can derive a pairwise master key (PMK), from which various other encryption keys can be determined, including a key confirmation key (KCK) and a key encryption key (KEK). Thus, in embodiments in which a SSID includes a Fingerprint, encryption keys (PMK, KCK, KEK) can be generated with such a Fingerprint.

STA 202 can send a first confirmation message 212-0 that can include a first confirmation (confirm1) generated using exchanged SAE factors and other values (e.g., KCK). AP 204 can generate a second confirmation message 212-1 that can include a second confirmation value (confirm2), as well as public key infrastructure related data. In the embodiment shown, such data can include public key AP_K corresponding to AP 204, an encrypted modifier value (i.e., M), as well as a digital signature signed using a private key AP_k, which corresponds to public key AP_K. Thus, in embodiments in which a SSID includes a Fingerprint, confirmations (conf1, conf2) can be generated using a Fingerprint.

A STA 202 can determine if a confirmation message 212-0 is correct 214-0. Such an action can include a STA 202 decrypting the message with a mutual key (e.g., KEK) to determine the modifier value. STA 202 can then compute an expected fingerprint (Fingerprint_Expected) value using AP_K, decrypted modifier, and SSID (or portion thereof). Fingerprint_Expected can be checked against a system Fingerprint value. In some embodiments, a system Fingerprint value can be present in the SSID for the AP 204. In other embodiments, a system Fingerprint value can be part of a PDC of the STA 202. If Fingerprint_Expected matches a system Fingerprint, AP_K can be considered to be trustworthy. STA 202 can then validate the digital signature using AP_K. In some embodiments, a STA 202 can store AP_K as a “trusted” public key, and forgo the calculation of a Fingerprint_Expected in a subsequent authentication operation with AP 204. If a STA 202 determines a confirmation message is not correct (N from 214-0), communications with the AP can stop 216.

If a STA 202 determines a confirmation message is correct (Y from 214-0), a STA can determine that the AP_K and seed values for encryption keys can be trusted. A STA 202 can then transmit an association request 220 to AP 204 that can include a hash of its PDC (Hash(PDC)) encrypted with a mutual key (e.g., KEK). In some embodiments, an association request 220 may include a vendor specific element that includes values confirm1, confirm2, and Hash(PDC) encrypted with KEK.

AP 204 can determine if a confirmation message 212-0 is correct 214-1. Such an action can include AP 204 calculating an expected value using a received confirmation1. If AP 204 determines that a confirmation message is not correct (N from 214-1), communications with the STA can stop 218.

If AP 204 determines that a confirmation message is correct (Y from 214-1) and then receives an association request 220, AP 204 can accept or reject the association request 232. If a received association request does not include a predetermined field (e.g., vendor specific element), AP can reject it (N from 232). If a received association request does includes the predetermined field, but the value of the field does not match values contained in the ACL 224, the AP can reject it (N from 232). A rejection can result in the transmission of an association response 232-0 to the STA 202 indicating an error. If a predetermined field of the association request 220 contains a PDC related value contained in the AP's ACL 224 (e.g., Hash(PDC)), AP 204 can continue the association process with an association response 232-1. An AP can then provide differentiated operations based on the PDC related value.

Referring still to FIG. 2, a table 238 shows how system values can vary according to embodiments. In one embodiment 234-0, a PDC 222 maintained securely by a STA can be a device specific component (e.g., mysecret) 236-0, and not include a Fingerprint. However, an SSID 225 broadcast by an AP can include a Fingerprint 236-1 separated from a system specific value by a separation character, such as a colon (e.g., MySSID:a2bc-de3f-ghi4). In another embodiment 234-1, a PDC 222 can have a device specific component 236-0 separated from a Fingerprint 236-1 by a separation character (e.g., a2bc-de3f-ghi4:mysecret), while an SSID may not include a Fingerprint (e.g., MySSID).

In this way, a system can include a system fingerprint value generated using public key values of an AP that is included in an SSID, or alternatively included in a secret PDC of a STA. A STA can determine if an AP and its public key can be trusted by generating its own expected fingerprint can comparing it to a system fingerprint. A STA can then transmit a hash of its PDC to the AP. The AP can differentiate access and/or services based on the hash of the PDC.

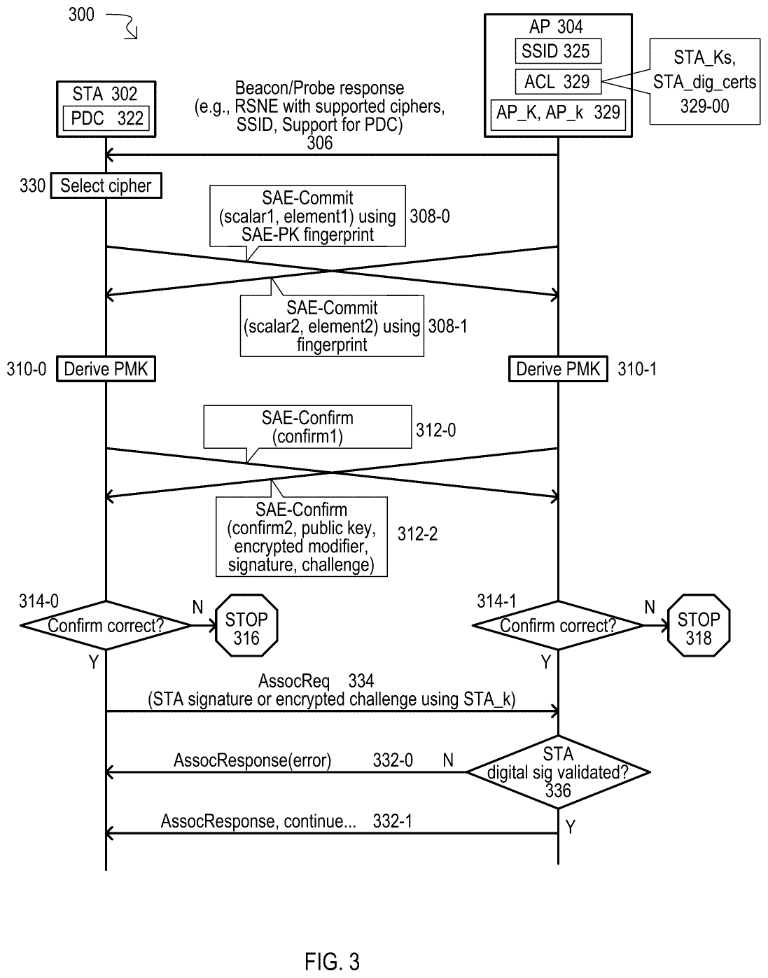

FIG. 3 is a signaling diagram of a system 300 and operations according to another embodiment. A system 300 can include items like those of FIG. 2, and such like items are referred to by the same reference character but with the leading digit being a “3” instead of “2”. A system 300 can include a STA 302 that stores a PDC 322, an AP 304 that provides a SSID 325, includes an ACL 329, and operates according to a public/private key pair (AP_k/AP_K). AP 304 can transmit a beacon/probe response 306 and STA 302 can select a cipher 330.

STA and AP (302, 304) can exchange SAE commit factors 308-0/1, derive encryption key(s) 310-0/1, exchange confirmation messages 312-0/2, and determine if confirmations are correct 314-0/1, 316, 318. In response to a correct confirmation (Y from 314-0), a STA 302 can transmit an association request 334 to AP 304. If an AP determines that an association request includes a STA digital signature that is valid (Y from 336), an AP can continue an association process 332-1.

A system 300 and corresponding operations can differ from that of FIG. 2 in that an AP ACL 329 can include STA public keys (STA_Ks) and/or STA digital certificates (STA_dig_certs) 329-00. In some embodiments, an AP confirm message 312-2 can include a challenge value for digital signature by a STA. A STA association request 334 can include a digitally signed value (e.g., a value signed using STA_k), which in some embodiments, can be a challenge value provided by AP 304. An AP 304 can validate a digital signature using a corresponding STA_K 336. In some embodiments, such an action can include an AP determining if the corresponding STA digital certificate and/or STA_K are stored in ACL 329.

In this way, a system can include a system fingerprint value generated using public key values of an AP that is included in an SSID, or alternatively in a secret PDC of a STA. A STA can determine if an AP and its public key can be trusted by generating its own expected fingerprint can comparing it to a system fingerprint. A STA can then transmit a digitally signed value to the AP. The AP can validate the STA using the STAs public key, and then provide differentiated access and/or services based on a STA's digital certificate and/or public key.

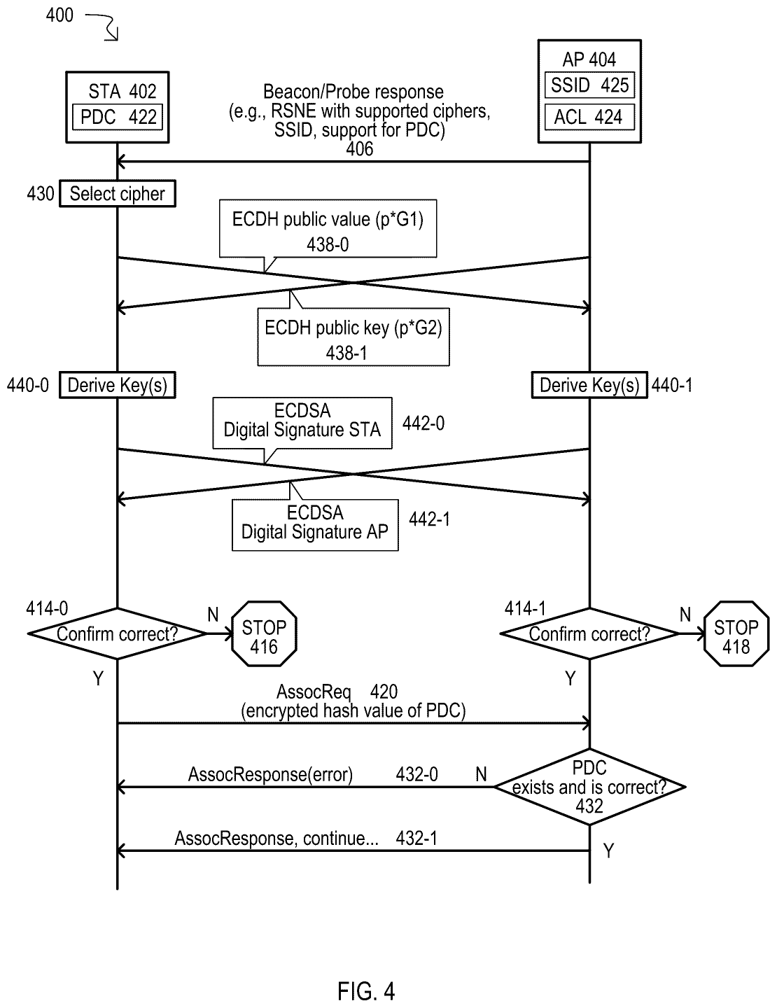

FIG. 4 is a signaling diagram of a system 400 and operations according to another embodiment. A system 400 can include items like those of FIG. 2, and such like items are referred to by the same reference character but with the leading digit being a “4” instead of “2”. A system 400 can include a STA 402 that stores a PDC 422, an AP 404 that provides a SSID 425 and includes an ACL 424. AP 404 can transmit a beacon/probe response 406 and STA 402 can select a cipher 430.

Unlike FIG. 2, a system 400 can include an Elliptic-Curve Diffie-Hillman (ECDH) type exchange between STA 402 and AP 404 to derive encryption keys. This can include STA 402 transmitting a first message 438-0 that can include a first element (p1*G) generated according to ECDH techniques (e.g., p1 can be a STA's secret value, and G can be a base point on an agreed upon elliptic curve). Similarly, AP 404 can transmit a second element (p2*G) (where p2 can be an AP's secret value). Using their respective secrets and received element, STA 402 and AP 404 can generate one or more mutual encryption keys 440-0/1. In the embodiment shown, STA 402 and AP 404 can send confirmations to one another using digital signatures based on ECDH (i.e., ECDSA) 442-0/1. A STA 402 and AP 404 can determine if received confirm messages are correct 414-0/1. Such an action can include a device using its secret value (i.e., p1 or p2) and the other device's transmitted element (i.e., p1*G or p2*G) to confirm a hash of the confirmation message.

Operations can then continue as described for FIG. 2, with STA 402 transmitting an association request 420 that can include a Hash(PDC) value, and AP 404 continuing association operations 432-1 if a received Hash(PDC) value is present in its ACL 432, else sending an error message 432-1.

In this way, a system can include an ECDH exchange and subsequent signature exchange to enable a STA and AP to authenticate one another. A STA can then transmit an association request with a hash of its PDC. If the AP can find the hash of the PDC of the STA in its ACL, the STA can provide differentiate access and/or services based on such a value.

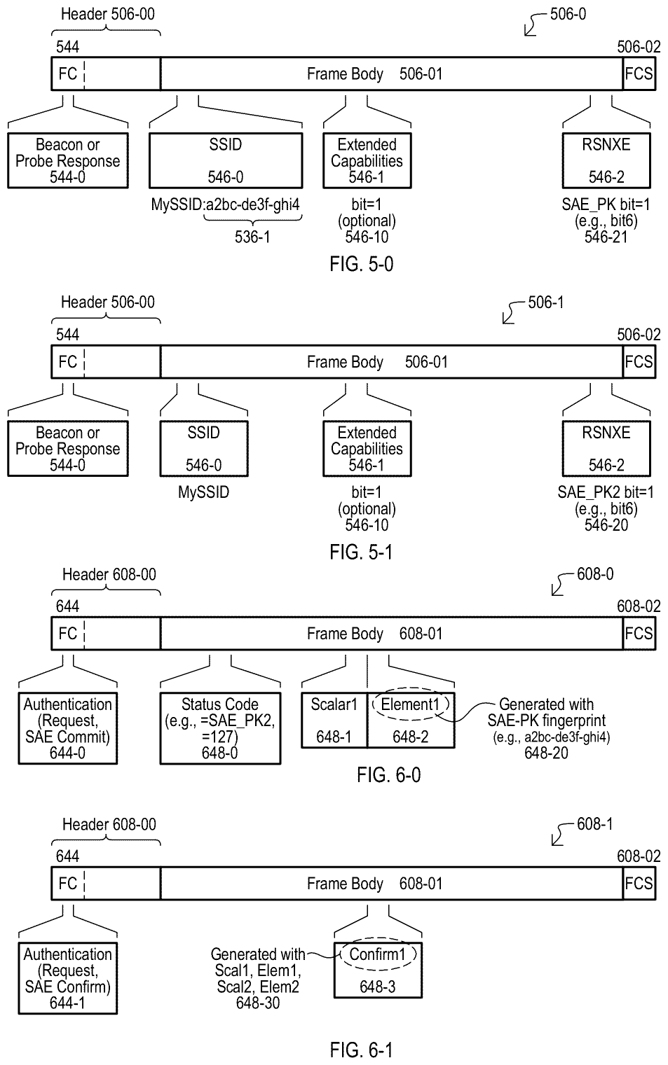

FIGS. 5-0 and 5-1 are diagrams of data frames according to embodiments. FIG. 5-0 shows a data frame 506-0 that can be a beacon or a probe response transmitted by an AP. A data frame 506-0 can include a header 506-00, body 506-10 and frame check sequence (FCS) 506-02. A header 506-00 can include a frame control (FC) field 544 that can include values 544-0 indicating that the data frame is a beacon or probe response. A frame body 506-01 can include an SSID field 546-0, extended capabilities field 546-1 and robust security network extended capabilities (RSNXE) field 546-2. In the embodiment shown, SSID field 546-0 can include a value having a Fingerprint 536-1 as described herein or an equivalent. An extended capabilities field 546-1 can include a value (e.g., a predetermined bit set to “1”) 546-10 that indicates additional capabilities (e.g., support for differentiated access/services based on PDC are supported. A RSNXE field 546-2 can include a value 546-21 (e.g., SAE_PK2 bit, bit 6) that indicates particular support for PDC based differentiated services as described herein (e.g., STA can check expected Fingerprint against Fingerprint portion in SSID, Fingerprint included in generation of SAE factors).

In this way, embodiments can include beacon and/or probe response data frames that include a SSID field having a portion of which includes a Fingerprint, as well as fields indicating support for PDC-based differentiated services.

FIG. 5-1 shows a beacon or response data frame 506-1 according to another embodiment. A beacon/response data frame 506-1 can be transmitted by an AP, and can include items like those of FIG. 5-0, and such like items are referred to by the same reference characters. Data frame 506-1 can differ from that of FIG. 5-0 in that a SSID field 546-0 can include a value without a Fingerprint, and an RSNXE field 546-2 can include a value 546-23 that can indicate a different kind of support of PDC based differentiated services as described herein (e.g., STA can check expected Fingerprint against Fingerprint portion in PDC, Fingerprint included in generation of SAE factors).

In this way, embodiments can include beacon and/or probe response data frames that include a SSID field without a Fingerprint, as well as fields indicating support for PDC-based differentiated services.

FIGS. 6-0 and 6-1 are diagrams of data frames that can be transmitted by a STA according to embodiments. FIG. 6-0 shows a data frame 608-0 that can be an SAE commit message. A data frame 606-0 can include a header 608-00, body 608-10 and FCS 608-02. A header 608-00 can include a FC field 644 that can include a value 644-0 that indicates an authentication data frame (e.g., an SAE commit data frame transmitted by a STA). A frame body 608-01 can include a status code 648-0 that indicates public key SAE in support of PDC differentiated services (e.g., SAE_PK2), a scalar field 648-1 that can include a scalar1 value, an element field 648-2 that can include an element1 value. A value element1 can be generated using a Fingerprint 648-20, as described herein or equivalents.

In this way, embodiments can include an SAE commit data frame from a STA that includes a field indicating support for PDC-based differentiated services, as well as SAE components (e.g., element) that can be generated using a Fingerprint value derived from AP public key components.

FIG. 6-1 shows a data frame 608-1 that can be a SAE confirm message according to an embodiment. A confirm data frame 608-1 can include items like those of FIG. 6-0, and such like items are referred to by the same reference characters. Data frame 608-1 can differ from that of FIG. 6-0 in that a frame body 608-01 can include a confirm field 648-3 that can include a confirm1 value, which can be generated using a STA's SAE factors as well as those received from an AP (e.g., scalar1, scalar2, element1, element2). In some embodiments, values element1 and element2 can be generated with a Fingerprint, thus a confirm1 can be considered generated using a Fingerprint.

In this way, embodiments can include an SAE confirm data frame from a STA, which in some embodiments can include a confirm value generated using a Fingerprint value derived with AP public key components.

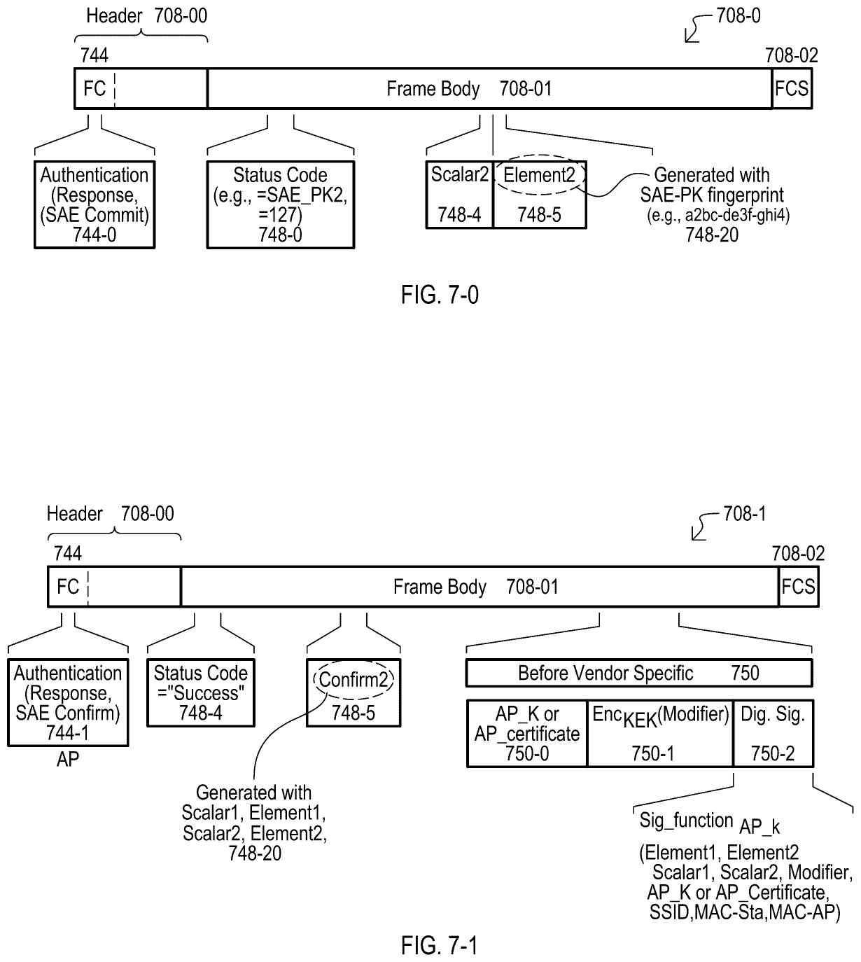

FIGS. 7-0 and 7-1 are diagrams of data frames that can be transmitted by an AP according to embodiments. FIGS. 7-0 and 7-1 can include items like those of FIG. 6-0, and such like items are referred to by the same reference characters but with the leading digit being a “7” instead of a “6”. FIG. 7-0 shows a data frame 708-0 that can be an SAE commit message. A data frame 708-0 can include its own scalar and element fields 748-4/5 that can include scalar2 and element2 values. In some embodiments, an element2 value can be generated using a Fingerprint 748-20.

In this way, embodiments can include an SAE commit data frame from an AP having a field indicating support for PDC-based differentiated services, as well as SAE components (e.g., element) that can be generated using a Fingerprint value derived from AP public key components.

FIG. 7-1 shows a data frame 708-1 that can be a SAE confirm message according to an embodiment. Data frame 708-1 can differ from that of FIG. 6-1 in that a frame body 708-01 can include a confirm field 748-5 that can include a confirm2 value. In addition, frame body 708-01 can include one or more additional fields that can include an AP_K or a digital certificate for an AP 750-0, a modifier value encrypted with a mutual key (e.g., KEK) 750-1, and a digital signature 750-2 from the AP. In some embodiments, a digital signature 750-2 can be generated with a predetermined signature function that signs a message with AP_k, which can be validated with a corresponding AP_K. In the embodiment shown, a message to be signed can include, or be created with, values element1, element2, scalar1, scalar2, modifier, either AP_K or a digital certificate for AP, an SSID, and the address of the target STA and address of the AP (e.g., MAC addresses). It is noted that in some embodiments, such an SSID can include a Fingerprint.

In this way, embodiments can include an SAE confirm data frame from an AP which in some embodiments can include a confirm value generated using a Fingerprint value derived with AP public key components, as well as a digital signature which can be validated using an AP's public key.

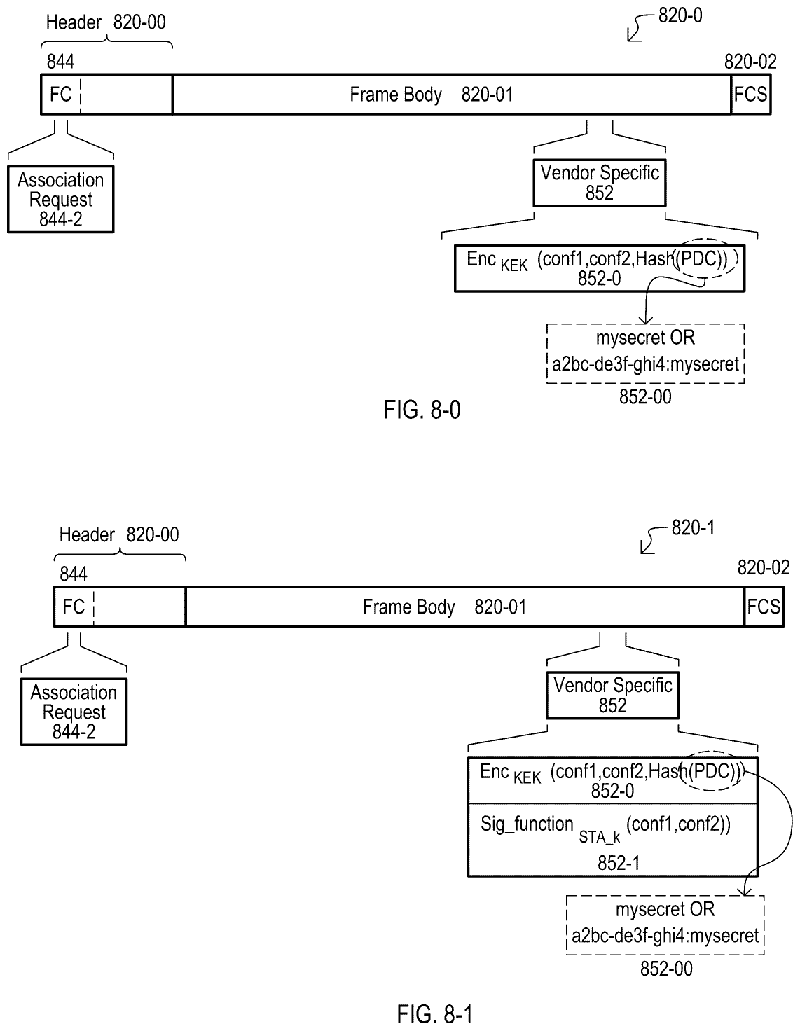

FIGS. 8-0 and 8-1 are diagrams of association request data frames that can be transmitted by a STA according to embodiments. FIG. 8-0 shows a data frame 820-0 that can include a header 820-00, body 820-01 and FCS 820-02. A header 820-00 can include a FC field 844 that can include values 844-2 indicating that the data frame 820-0 is an association request. A frame body 820-01 can include one or more vendor specific fields 852. Vendor specific field(s) can store a value 852-0 that includes a Hash(PDC) encrypted with a mutual key. In the embodiment shown, confirm1, confirm2 and Hash(PDC) can be encrypted with KEK. It is noted that in some embodiments, a PDC 852-00 from which Hash(PDC) is generated can include a Fingerprint along with a device specific value (e.g., a2bc-de3f-ghi4:mysecret). However, in other embodiments (e.g., in which a Fingerprint is an SSID), such a PDC can be a device specific value that does not include a Fingerprint (e.g., mysecret).

In this way, following authentication with an AP, a STA can transmit an association request to the AP that includes a hash of a PDC for the AP, encrypted with a mutual key.

FIG. 8-1 shows an authentication data frame 820-1 according to another embodiment. FIG. 8-1 can include items like those of FIG. 8-0, and such like items have the same reference characters. Data frame 820-1 can differ from those of FIG. 8-0 in that vendor specific field(s) can include a digital signature of the STA 852-1. A vendor specific field 852 may or may not also include an encrypted Hash(PDC) value 852-0. In the embodiment shown, a digital signature can sign a message with a private key (STA_k) that includes, or is generated from a confirmation1 and confirmation2 value. Such a digital signature can be validated with a public key for the STA (STA_K).

In this way, following authentication with an AP, a STA can transmit an association request to the AP that includes a STA digital signature, and possibly in addition, a hash of a PDC of the STA encrypted with a mutual key.

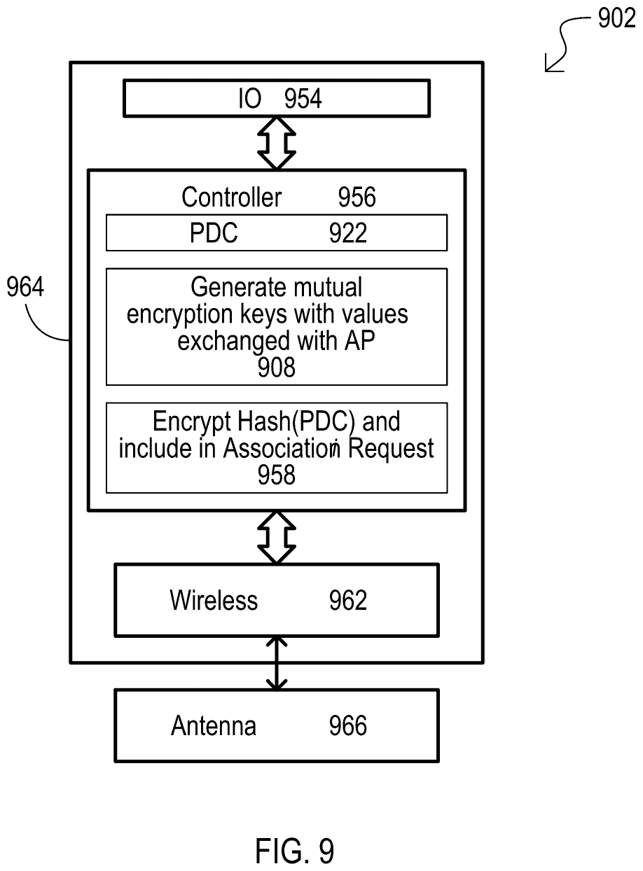

FIG. 9 is a block diagram of a wireless device 902 according to an embodiment. A wireless device 902 can be a device that can access a network and receive differentiated services with respect to other devices based on a PDC (e.g., a STA). Device 902 can include input/output (IO) circuits 954, controller circuits 956, and wireless circuits 962. IO circuit 954 can enable a device 902 to be controlled by external users or systems.

Controller circuits 956 can include any suitable circuits for executing wireless communications as described herein, and equivalents. Such suitable circuits can include but not limited to one or more processors, custom logic circuits, programmable logic circuits, machine learned/learning systems, or combinations thereof, as well as corresponding memory circuits and/or systems. Controller circuits 956 can store a PDC 922 in a secure fashion. A PDC 922 can take the form of any of those described herein or equivalents, including with or without a Fingerprint portion. Controller circuits 956 can generate mutual encryption keys with values exchanged with an AP 908. Such an action can include a device 902 transmitting one or more values to an AP derived according to a predetermined encryption/cipher scheme, and receiving like value(s) from the AP. Such transmitted and received values can then be used to derive one or more mutual encryption keys. Controller circuits 956 can encrypt a Hash(PDC) value and include such a value in an association request 958. Such an action can take the form of any of those described herein or equivalents.

Wireless circuits 962 can include circuits compatible with one or more standards, including public and/or private standards. In some embodiments, wireless circuits 968 compatible with one or more IEEE 802.11 wireless standards and/or one or more standards promulgated by the Wi-Fi Alliance.

In some embodiments, IO circuits 954, controller circuits 956 and wireless circuits 962 can be part of a same integrated circuit substrate 964. A wireless device 902 operate in conjunction with an antenna system 966.

In this way, a wireless device can include circuits for storing a secret PDC, generating mutual encryption keys with another wireless device through an exchange of values, and transmit a hash of the PDC encrypted with a mutual key.

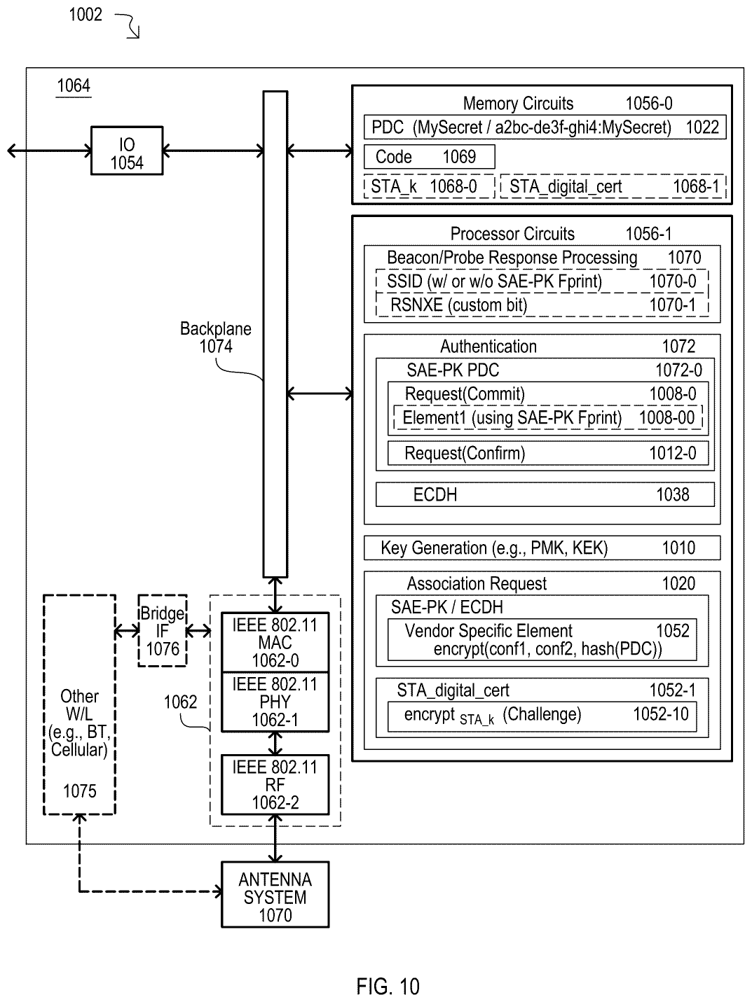

FIG. 10 shows a device 1002 according to another embodiment. In some embodiments, a device 1002 can be a STA in systems as described herein. A device 1002 can include IO circuits 1054, memory circuits 1056-0, processor circuits 1056-1, wireless circuits 1062, and optionally, other wireless circuits 1075 and bridge circuits 1076. Such device portions can be connected to one another over a backplane/bus 1074.

Memory circuits 1056-0 can include any suitable memory circuits, including nonvolatile memory with secure storage locations, and optionally, volatile memory. Memory circuits 1056-0 can store data for enabling the various operations of wireless device 1002, including a PDC 1022 and code 1069. Code 1069 can include instructions (e.g., firmware) executable by processor section 1056-1 to provide the various processor operations described herein. In some embodiments, memory circuits 1056-0 can include a private key 1068-0 and/or a digital certificate 1068-1.

Processor circuits 1056-1 can execute code 1069 to provide various operations for the device 1002 that include, but are not limited to, beacon/probe response processing 1070, authentication 1072, key generation 1010 and association request generation 1020. Beacon/probe response processing 1070 can include determining an SSID 1070-0 and detecting one or more predetermined RSNXE bits 1070-1. In some embodiments, determining an SSID 1070-0 can include determining a Fingerprint (e.g., SAE-PK Fprint) portion from an SSID. However, as noted herein, other embodiments do not include a Fingerprint in an SSID. A predetermined RSNXE bit 1070-1 can indicate an AP supports PDC-differentiated services, as well as processes for authentication.

Authentication 1072 can include, but is not limited to, SAE-PK PDC type authentication 1072-0 and/or ECDH type authentication 1038. SAE-PK PDC type authentication 1072-0 can include the generation of an authentication request 1008-0 (i.e., commit message) that includes an element1. In some embodiments, an element1 can be generated using a Fingerprint 1008-00. However, in other embodiments this may not be the case. SAE-PK PDC type authentication can also include the generation of another authentication request 1012-0 (i.e., confirm message). Such a message can include a confirm1 value as described for embodiments herein.

In addition or alternatively, authentication 1072 can include ECDH type authentication 1038, along with a digital signature operation based on a public/private key, which may or may not include ECDSA.

Key generation 1010 can include deriving mutual encryption keys based on values exchanged with an AP. Such key generation can take the form of any of those described herein and equivalents, including but not limited to deriving a PMK (and resulting KEK) using a seed value that in some embodiments can include a Fingerprint, but in other embodiments will not include a Fingerprint.

Generating an association request 1020 can include encrypting a set of values with a mutual key (e.g., KEK), where such values include a Hash(PDC) 1052. In the embodiment shown, encrypted values can include a locally generated conf1, a received conf2, and Hash(PDC). In addition or alternatively, an association request can include data related to a STA digital certificate 1052-1. In some embodiments, such data can include the digital certificate itself or a STA_K. In some embodiments, a challenge value provided by an AP can be encrypted using STA_k, and can be transmitted in the association request.

Wireless circuits 1062 can provide wireless communications compatible with one or more IEEE 802.11 wireless standards. Wireless circuits 1062 can include MAC layer circuits 1062-0, physical layer (PHY) circuits 1062-1, and RF circuits 1062-2. Such circuits (1062-0, -1, -2) can operate on any suitable band, including but not limited to the 2.4 GHz, 5 GHz and/or 6 GHz bands.

IO circuits 1054 can input signals that can enable control of a device 1002, and output data from the device 1002 according to any suitable fashion. In some embodiments, IO circuits 1054 can include serial communication circuits, including but not limited to interfaces compatible with a serial digital interface (SDI), universal serial bus (USB), universal asynchronous receiver transmitter (UART), 12C, or 12S.

Optional bridge interface circuits 1076 can enable communications between wireless circuits 1062 and other wireless circuits 1075. In some embodiments, such communications can determine which wireless circuits (1062 or 1074) can control a shared medium (e.g., 2.4 GHz band).

Other wireless circuits 1075 can be one or more wireless circuits compatible with a standard different from that of wireless circuits 1062, including but not limited to, one or more Bluetooth standards, one or more IEEE 802.15.4 or related standards and/or one or more cellular network standards.

A device 1002 can operate in conjunction with an antenna system 1070 having one or more antennas compatible with one or more IEEE 802.11 wireless standards, as well as other standards if another wireless section 1075 is included.

In some embodiments, IO circuits 1054, memory circuits 1056-0, processor circuits 1056-1, and wireless circuits 1062 can be formed with a same integrated circuit substrate 1064.

In this way, a STA can store a PDC and/or operate according to a digital certificate. After authentication with an AP, the STA can transmit an encrypted Hash(PDC) value and/or a digital certificate value, from which an AP can differentiate services for the STA.

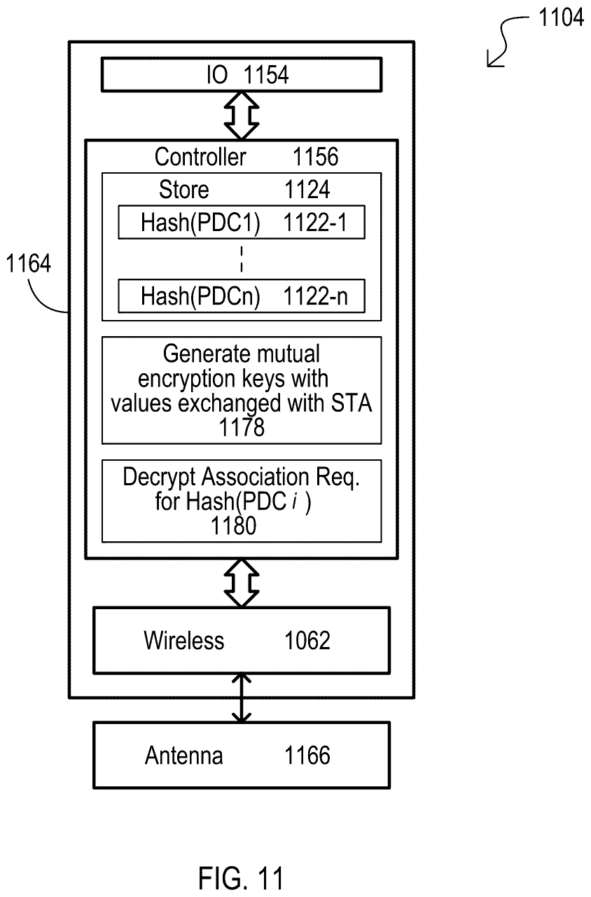

FIG. 11 is a block diagram of a wireless device 1104 according to another embodiment. A wireless device 1104 can control access to a network and provide differentiated services to devices joining a network based on their PDC. Device 1104 can include items like those of FIG. 9, and such like items are referred to by the same reference character but with the leading digits being “11” instead of “9”. Thus, wireless device 1104 can include IO circuits 1154, a controller circuits 1156, wireless circuits 1062, a substrate 1164, and can operate with an antenna system 1166.

Controller circuits 1156 can include a store 1124 that can include, for various different devices, a hash of their PDC (1122-1 to 1122-n). A device 1104 can compare a received value (i.e., Hash(PDCI)) against stored values (1122-1 to 1122-n). If a match exists, a device 1104 can provide differentiated services corresponding to the match. Controller circuits 1156 can generate mutual encryption keys with values exchanged with a STA 1178. Controller circuits 1156 can also decrypt at least a portion of an association request to determine a hash of a PDC value included therein (e.g., Hash(PDCI)) 1180.

In this way, a wireless device can include circuits for storing hashes of PDC values for different devices, generate mutual encryption keys with another wireless device through an exchange of values, and determine differentiated services for such other device based on a hash of the PDC encrypted in a message from the device.

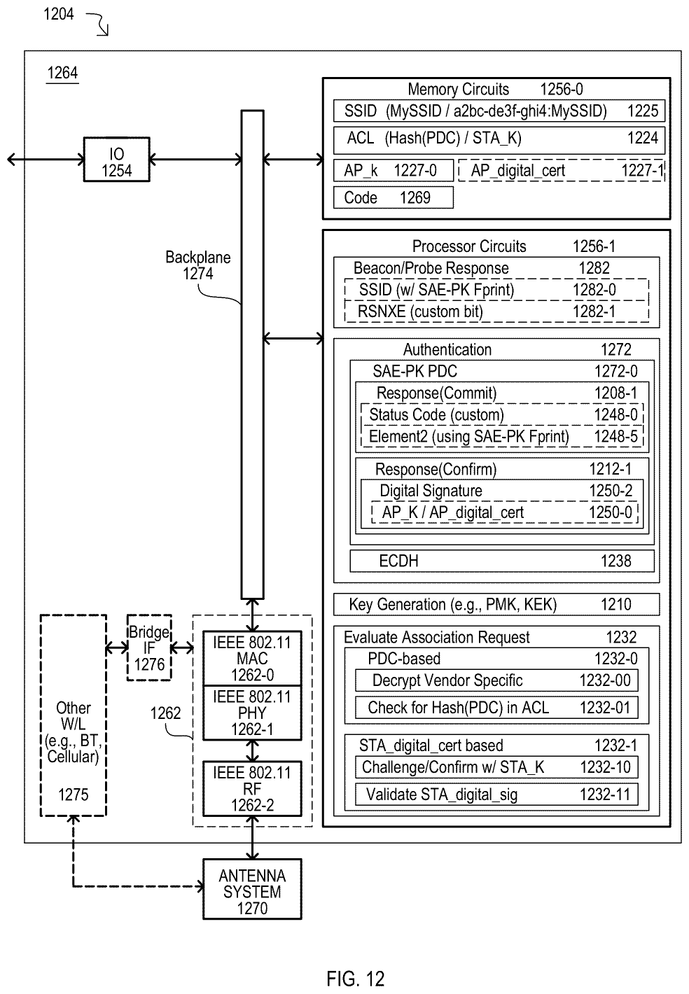

FIG. 12 shows a device 1204 according to another embodiment. In some embodiments, a device 1204 can be an AP in systems as described herein. A device 1204 can include items like those of FIG. 10, and such like items are referred to by the same reference characters but with the leading digits being “12” instead “10”. Accordingly, a device 1204 can include IO circuits 1254, memory circuits 1256-0, processor circuits 1256-1, wireless circuits 1262 (including MAC circuits 1262-0, PHY circuits 1262-1, and RF circuits 1262-2), a backplane/bus 1274, and optionally, other wireless circuits 1275 and bridge circuits 1276. A device 1204 can operate with an antenna system 1270.

Memory circuits 1256-0 can store an SSID 1225, ACL 1224, an AP_k 1227-0, and code 1269. In some embodiments, memory circuits 1256-0 can store a digital certificate for the device 1227-1. which can include a Fingerprint in some embodiments.

Processor circuits 1256-1 can generate a beacon and/or probe response 1282 that can include a SSID 1282-0 and RSNXE 1282-1 bit value. As noted herein, and SSID 1282-0 may or may not include a Fingerprint. Authentication 1272 can include, but is not limited to, SAE-PK PDC type authentication 1272-0 and/or ECDH type authentication 1238-0. SAE-PK PDC type authentication 1272-0 can include the generation of an authentication response 1208-1 (i.e., commit message) that includes a status code 1248-0 and element2 1248-5 as described herein, or an equivalent. In some embodiments, element2 1248-5 can be generated using a Fingerprint. Operations can include a second authentication response 1212-1 (i.e., confirm message). Such a message can include a confirm2 value as described for embodiments herein. In addition or alternatively, authentication 1272 can include ECDH type authentication 1238.

Key generation 1210 can include deriving mutual encryption keys as noted herein and equivalents.

Processor circuit operations can include evaluating an association request 1232. Such operations can be PDC-based 1232-0 or STA digital certificate based 1232-1. PDC-based evaluation 1232-0 can include decrypting a vendor specific field 1232-00 and then determining if a Hash(PDC) value is present in ACL 1232-01. STA digital certificate based 1232-1 evaluation can include decrypting a challenge value with a STA_K 1232-10 and/or validating a digital signature signed by a STA using the STA's STA_K 1232-11.

In this way, after authentication with a STA, an AP can process an association request from the STA by decrypting a vendor specific field to determine if a Hash(PDC) value contained therein exists in an ACL and/or validate the message using a STA's public key.

While the systems, operations and devices herein have shown various methods, additional methods will now be described with reference to a flow diagrams.

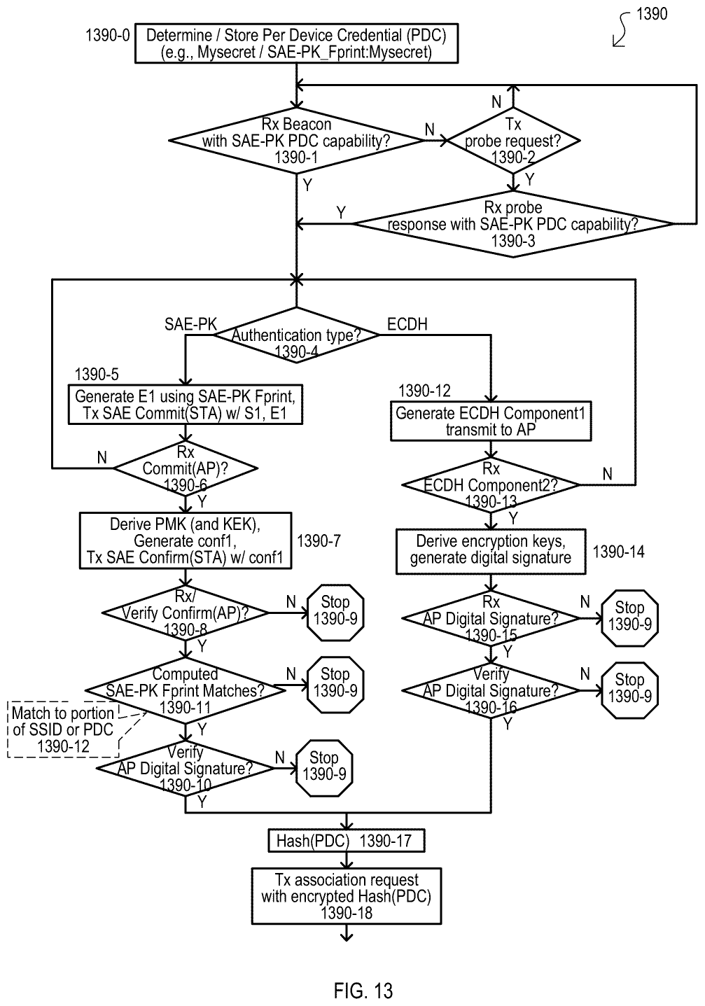

FIG. 13 is a flow diagram of a method 1390 according to an embodiment. A method 1390 can include actions, all or a portion of which can be executed by a STA as described herein and equivalents. A method 1390 can determine and store a PDC value 1390-0. Such a value can be determined all, or in part, by a manufacturer and/or user. As understood from embodiments herein, in some embodiments a PDC does not have to include a Fingerprint. However, in other embodiments a PDC can include a device specific value separated from a Fingerprint by a predetermined character.

A method 1390 can include determining if a beacon that indicates support for PDC differentiated services has been received 1390-1. If such a beacon is not received a method 1390 can determine whether or not to transmit a probe request 1390-2. If a probe request is transmitted (Y from 1390-2), a method 1390 can include determining if a corresponding probe response has been received 1390-3. If a beacon or probe response indicating support for PDC-differentiated services is received (Y from 1390-1 or 1390-3), a method 1390 can vary according which type of authentication is indicated by a beacon/probe response.

If a SAE-PK type authentication is indicated (SAE-PK from 1390-4), a method can include generating an element (E1) using a Fingerprint value, and transmitting a SAE commit message that includes E1 and a corresponding S1 1390-5. If a corresponding commit message is not received from an AP (N from 1390-6), authentication can stop or restart. If a corresponding commit message is received (Y from 1390-6), encryption keys can be derived (e.g., PMK and KEK), a confirmation value (confirm1) can be generated, and a SAE confirm message can be transmitted with the confirmation value 1390-7. If a confirm value (e.g., confirm2) is not received from an AP or a confirm value is determined not to be correct (N from 1390-8), communications with the AP can stop 1390-9.

If a received confirm value is determined to be correct (Y from 1390-8), a method 1390 can compute an expected Fingerprint, and determine if it matches a system Fingerprint 1390-11. Such an action can include comparing an expected Fingerprint to a portion of an SSID or to a portion of a PDC 1390-12. If such Fingerprint values do not match (N from 1390-11), communications with the AP can stop 1390-9. A method 1390 can attempt to verify an AP digital signature 1390-10. If a signature is not verified (N from 1390-10), communications with the AP can stop 1390-9.

If ECDH type authentication is indicated (ECDH from 1390-4), a method can include generating an ECDH component and transmitting such a value to an AP 1390-12. If a corresponding component is received (Y from 1390-13), encryption keys can be derived and digital signatures generated 1390-14. If a digital signature from an AP is not received (N from 1390-8), communications with the AP can stop 1390-9. If a digital signature is not received or not verified (N from 1390-16), communications with the AP can stop 1390-9.

If authentication with an AP is successful (Y from 1390-11 or Y from 1390-16), a method 1390 can generate a hash of a stored PDC (Hash(PDC)) 1390-17. Hash(PDC) can be encrypted and then transmitted to an AP 1390-18.

In this way, a method can include authenticating with an AP by exchanging values, and then encrypting a hash of the PDC and transmitting it within an association request.

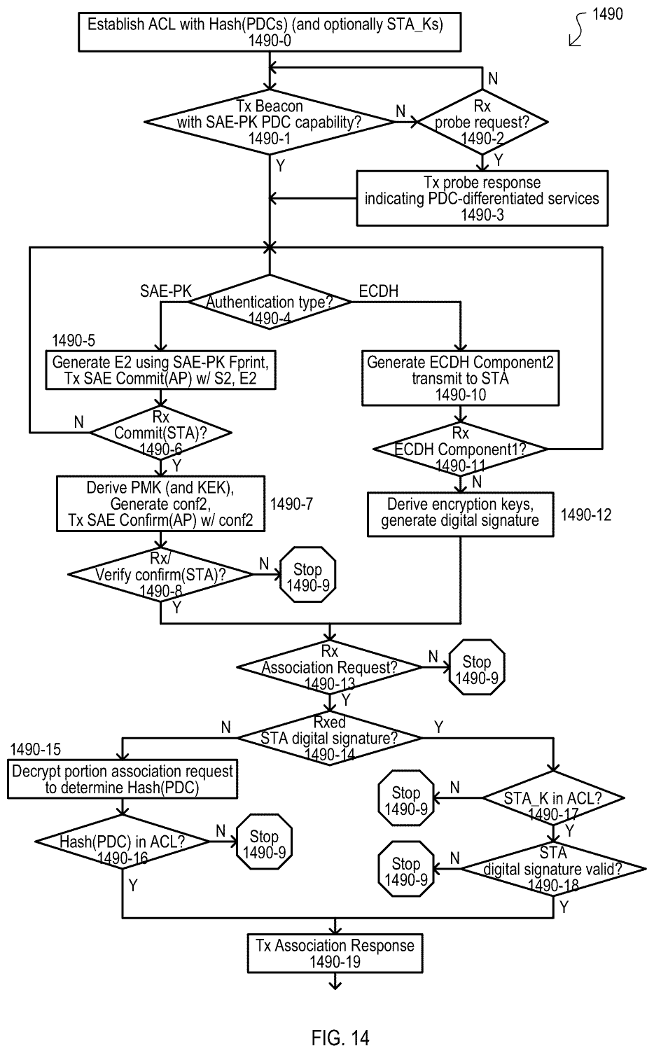

FIG. 14 is a flow diagram of a method 1490 according to another embodiment. A method 1490 can include actions, all or a portion of which can be executed by an AP as described herein and equivalents. A method 1490 can include establishing an ACL 1490-0 that includes Hash(PDC) values, and optionally, public keys of STAs (STA_Ks). A method 1490 can determine if a beacon is to be transmitted that indicates support for PDC differentiated services 1490-1. If such a beacon is not transmitted, a method 1490 can determine whether or not a probe request is received 1490-2. If a probe request is received (Y from 1490-2), a method 1490 can return a probe response indicating support for PDC differentiated services 1490-3.

If SAE-PK type authentication is indicated (SAE-PK from 1490-4), a method can include generating E2 using a Fingerprint value, and transmitting a SAE commit message that includes E2 and a corresponding S2 1490-5. If a corresponding commit message is not received from a STA (N from 1490-6), authentication can stop or restart. If a corresponding commit message is received (Y from 1490-6), encryption keys can be derived, a confirmation value (confirm2) can be generated, and a SAE confirm message can be transmitted with the confirmation value 1490-7. If a confirm value (e.g., confirm1) is not received from a STA or such a value is determined not to be correct (N from 1490-8), communications with the AP can stop 1490-9.

If ECDH type authentication is indicated (ECDH from 1490-4), a method can include generating an ECDH component and transmitting such a value to a STA 1490-10. If a corresponding component is received (Y from 1490-11), encryption keys can be derived and a digital signature generated 1490-12.

If authentication with a STA is successful (Y from 1490-8 or from 1490-12), a method 1490 can determine if an association request is received 1490-13. If an association request is not received (N from 1490-13), communications with a STA can stop 1490-9. If an association request is received (Y from 1490-13), a determination can be made if a digital signature is included 1490-14.

If STA a digital signature is not included (N from 1490-14), a method 1490 can evaluate the association request for differentiated services based on a PDC. In the embodiment shown, a portion of an association request can be decrypted to determine a Hash(PDC) value 1490-15. If such a Hash(PDC) value is not present in the association request, or is present but does not match a value in an ACL (N from 1490-16), communications with the STA can end 1490-9. If a decrypted Hash(PDC) value matches a corresponding value in an ACL (Y from 1490-16), a method 1490 can transmit an association response 1490-19 and association can continue.

If a STA digital signature has been received (Y from 1490-14), a method 1490 can evaluate the association request for differentiated services based on validating the digital signature. In the embodiment shown, a method 1490 can determine if a STA_K corresponding to the digital signature is present in an ACL 1490-17. If such a value is not present (N from 1480-17), communications with the STA can end 1490-9. If a STA_K exists in an ACL (Y from 1490-17), a method 1490 can determine if the digital signature is valid (e.g., using a corresponding STA_K). In some embodiments, such a STA digital signature can include a challenge value previously provided by an AP (e.g., in a confirm message). If a digital signature is not valid (N from 1490-18), communications with the STA can end 1490-9. If a digital signature is valid (Y from 1490-18), association can continue with the transmission of an association response 1490-19.

In this way, a method can include authenticating with a STA by exchanging values, and then providing differentiated on an encrypted Hash(PDC) value or a digital signature provided in an association request.

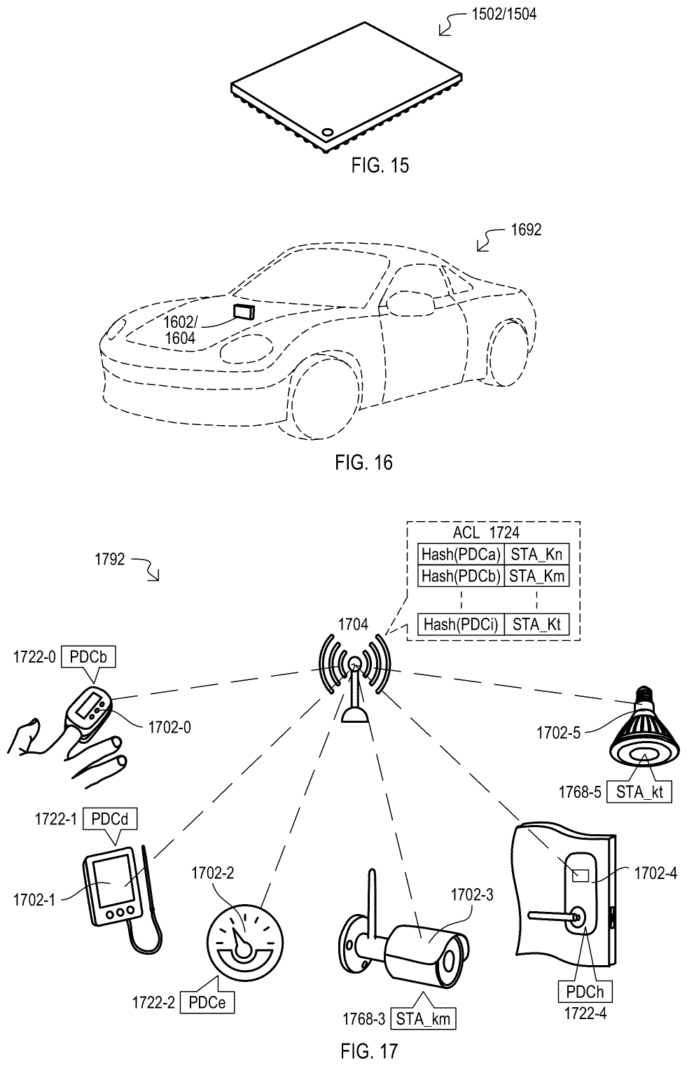

While embodiments can include devices with various interconnected components, embodiments can also include devices capable of PDC based network access as described herein and equivalents. In some embodiments, such unitary devices can be advantageously compact single integrated circuits (IC). FIG. 15 shows a packaged IC device 1502/1504 that can execute communications as a STA or AP according to embodiments shown herein and equivalents. In some embodiments, a device 1502/1504 can include a substrate 946, 1064, 1164, 1264 as described herein or an equivalent. While FIG. 15 shows a particular package, alternate embodiments can include any other suitable integrated circuit packaging type, as well as direct bonding of a device chip onto a circuit board or substrate.

In this way, a STA which can receive differentiated services based on its PDC from an AP and/or an AP that provides differentiated services based on a PDC as described herein can take the form of an integrated circuit device.

However, it is understood that a device according to embodiments can include any other suitable integrated circuit packaging type, as well as direct bonding of a device chip onto a circuit board or substrate.

Embodiments can enjoy application in subsystems of motor vehicles to enable such a vehicle to receive differentiated services and/or provide differentiated services based on a PDC and/or digital signature. FIG. 16 shows a motor vehicle system 1692 according to another embodiment. A motor vehicle system 1692 can include one or more subsystems (e.g., in-vehicle infotainment system) that can include, or be configured to provide, a STA 1602 and/or AP 1604 as described herein or equivalents.

In this way, vehicles can include wireless systems that can provide or receive PDC-based differentiated services.

FIG. 17 shows a system 1792 according to a further embodiment. A system 1792 can include an AP 1702 and a number of STAs 1704-0 to 1704-5. An AP 1702 can include an ACL 1724 that can store hashes of PDCs for STAs (Hash(PDCa) to Hash(PDCi)) as well as public keys for STAs (STA_Kn to STA_Kt). STAs (1704-0 to 1704-5) can each include a PDC (1722-0, 1722-1, 1722-2, 1722-4) or private key (1768-3,1768-5).

An AP 1704 can execute authentication operations with STAs that can include public key data for the AP (e.g., SAE-PK authentication). Once devices are authenticated, a STA (1702-0 to 1702-5) can transmit an encrypted hash of its PDC or a digital signature signed with its private key. AP 1704 can then determine if its ACL 1724 stores a Hash(PDC) value and/or is in possession of the public key counterpart to the private key used in the digital signature. If an AP 1704 can identify a STA with such an operation, the AP 1704 can provide differentiated access/services assigned to the STA.

In the embodiment shown, STAs (1702-0 to 1702-5) can be “Internet-of-Things” (IoT) type devices, including but not limited to: medical devices 1702-0/1, instrumentation devices 1702-2, security devices 1702-3/4 and lighting devices 1702-5. However, such STAs are provided by way of example, and any other suitable device can receive differentiated services as described herein and equivalents.

In this way, various IoT devices can receive differentiated access and/or services from an AP after public key based authentication, based on a STA's PDC and/or digital certificate.

Embodiments can include methods, devices and systems that include by operation of a first wireless device, storing a PDC that distinguishes the wireless device from other wireless devices, in response to receiving an information data frame from an AP that indicates support for PDC authentication, transmitting at least one authentication data frame to the AP that includes at least a first element, receiving at least a one authentication data frame from the AP that includes at least a second element, generating at least one encryption key with at least the first and second elements, comparing an expected fingerprint to a system fingerprint, executing a hashing operation to generate a hash of the PDC, and transmitting an association request frame that includes at least the hash of the PDC encrypted with the at least one encryption key. The expected fingerprint can be a result of a predetermined hashing operation executed on at least a portion of a SSID of the AP and a public key corresponding to the AP.

Embodiments can include methods, devices and systems having memory circuits configured to store a per device credential (PDC) that distinguishes the device from other wireless devices; processor circuits configured to determine from an information data frame that an access point device (AP) supports PDC authentication, generate at least one authentication request addressed to the AP that includes at least one first element, generate at least one encryption key with at least first element and a second element received from the AP, compare an expected fingerprint to a system fingerprint, execute a hashing operation to generate a hash of the PDC, and generate an association request addressed to the AP that includes the hash of the PDC encrypted with the at least one encryption key. Wireless circuits can be configured to receive and transmit data frames. The expected fingerprint can be a result of a predetermined hashing operation executed on at least a portion of a SSID of the AP and a public key corresponding to the AP.

Embodiments can include methods, devices and systems having a STA that includes controller circuits configured to store at least a PDC that distinguishes the STA from other wireless devices, exchange at least elements with an AP, generate at least one encryption key with at least the elements, compare an expected fingerprint to a system fingerprint, transmit an association request to the AP that includes a hash of the PDC encrypted with the at least one encryption key. Wireless circuits can be included that are compatible with at least one IEEE 802.11 wireless standard, along with an antenna system coupled to the wireless circuits. The expected fingerprint can be a result of a predetermined hashing operation executed on at least a portion of a SSID of the AP and a public key corresponding to the AP.

Methods, devices and systems according to embodiments can include a PDC having at least a device specific portion.

Methods, devices and systems according to embodiments can include a PDC having a device specific portion and a system fingerprint.

Methods, devices and systems according to embodiments can include a PDC that does not include the system fingerprint, and an SSID can include an AP portion and the system fingerprint.

Methods, devices and systems according to embodiments can include an information data frame selected from the group consisting of: an beacon data frame compatible with at least one IEEE 802.11 wireless standard and a probe response data frame compatible with at least one IEEE 802.11 wireless standard.

Methods, devices and systems according to embodiments can include transmitting a SAE commit message that includes at least S1 and E1 generated with the expected or system fingerprint, receiving a SAE commit message that includes S2 and E2 generated with the expected or system fingerprint, transmitting a SAE confirm message that includes at least a first confirm value generated with at least S1, S2, E1 and E2, and receiving a SAE confirm message that includes a second confirm value generated with at least S1, S2, E1 and E2.

Methods, devices and systems according to embodiments can include, by operation of an AP, decrypting the association request to determine the hash of the PDC. In response to a hash of the PDC corresponding to a previously stored value, an association response can be transmitted to a wireless device.

Methods, devices and systems according to embodiments can include, by operation of an AP, in response to storing a public key corresponding to the wireless device, receiving and verifying a digital signature from the wireless device using the public key.

Methods, devices and systems according to embodiments can include controller circuits are configured to generate a SAE STA commit message that includes at least S1 and E1 generated with the expected or system fingerprint, generate a SAE STA confirm message that includes at least a first confirmation value generated with at least S1, E1 and S2 and E2 received from an AP SAE commit message, and receive an AP SAE confirm message that includes a second confirm value generated with at least S1, S2, E1 and E2. Wireless circuits can be configured to transmit at least the STA commit and confirm messages and receive at least the AP commit message.

Methods, devices and systems according to embodiments can include wireless circuits that are compatible with at least one IEEE 802.11 wireless standard. An information data frame can be selected from the group consisting of: a beacon and a probe response.

Methods, devices and systems according to embodiments can include an AP configured to store the hashes of PDCs for a plurality of different STAs, exchange at least the elements with the STA, generate the at least one encryption key with at least the elements, and decrypt at least a portion of the association request to determine the presence of the hash of the PDC. In response to the hash of the PDC matching one of the stored hashes of PDCs, transmitting an association response to the STA.

Methods, devices and systems according to embodiments can include an AP including an ACL configured to store at least the hashes of PDCs.

Methods, devices and systems according to embodiments can include an ACL further configured to store public keys for a plurality of STAs having digital certificates.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of a first wireless device,
storing a per device credential (PDC) that distinguishes the wireless device from other wireless devices,
in response to receiving an information data frame from an access point wireless device (AP) that indicates support for PDC authentication,
transmitting at least one authentication data frame to the AP that includes at least a first element,
receiving at least one authentication data frame from the AP that includes at least a second element,
generating at least one encryption key with at least the first and second elements,
comparing an expected fingerprint to a system fingerprint,
executing a hashing operation to generate a hash of the PDC, and
transmitting an association request frame that includes at least the hash of the PDC encrypted with the at least one encryption key; wherein
the expected fingerprint comprises a result of a predetermined hashing operation executed on at least a portion of a service set identifier (SSID) of the AP and a public key corresponding to the AP (AP_K).

2. The method of claim 1, wherein the PDC comprises at least a device specific portion.

3. The method of claim 2, wherein the PDC comprises the device specific portion and the system fingerprint.

4. The method of claim 2, wherein:
the PDC does not include the system fingerprint; and
the SSID includes an AP portion and the system fingerprint.

5. The method of claim 1, wherein the information data frame is selected from the group consisting of: a beacon data frame compatible with at least one IEEE 802.11 wireless standard and a probe response data frame compatible with at least one IEEE 802.11 wireless standard.

6. The method of claim 1, wherein
transmitting at least one authentication data frame and receiving at least one authentication data frame value includes
transmitting a simultaneous authentication of equals (SAE) commit message that includes at least a first scalar (S1) and first element (E1) generated with the expected or system fingerprint,
receiving a SAE commit message that includes at least a second scalar (S2) and second element (E2) generated with the expected or system fingerprint,
transmitting a SAE confirm message that includes at least a first confirmation value (conf1) generated with at least S1, S2, E1 and E2, and
receiving a SAE confirm message that includes a second confirm value generated with at least S1, S2, E1 and E2.

7. The method of claim 1, further including:
by operation of the AP
decrypting the association request to determine the hash of the PDC,
in response to the hash of the PDC corresponding to a previously stored value, and
transmitting an association response to the wireless device.

8. The method of claim 1, further including:
by operation of the AP,
in response to storing a public key corresponding to the wireless device (STA_K), and
receiving and verifying a digital signature from the wireless device using the STA_K.

9. A device, comprising:
memory circuits configured to store a per device credential (PDC) that distinguishes the device from other wireless devices;
processor circuits configured to
determine from an information data frame that an access point device (AP) supports PDC authentication,
generate at least one authentication request addressed to the AP that includes at least one first element,
generate at least one encryption key with at least first element and a second element received from the AP,
compare an expected fingerprint to a system fingerprint,
execute a hashing operation to generate a hash of the PDC, and
generate an association request addressed to the AP that includes the hash of the PDC encrypted with the at least one encryption key; and
wireless circuits configured to receive and transmit data frames; wherein
the expected fingerprint comprises a result of a predetermined hashing operation executed on at least a portion of a service set identifier (SSID) of the AP and a public key corresponding to the AP (AP_K).

10. The device of claim 9, wherein the PDC comprises at least a device specific portion.

11. The device of claim 10, wherein the PDC comprises the device specific portion and the system fingerprint.

12. The device of claim 9, wherein:
the PDC does not include the system fingerprint; and
the SSID includes an AP portion and the system fingerprint.

13. The device of claim 9, wherein:
the controller circuits are further configured to
generate a simultaneous authentication of equals (SAE) STA commit message that includes at least a first scalar (S1) and first element (E1) generated with the expected or system fingerprint,
generate a SAE STA confirm message that includes at least a first confirmation value (conf1) generated with at least S1, E1 and a second scalar S2 and second element (E2) received from an AP SAE commit message and
receive an AP SAE confirm message that includes a second confirm value generated with at least S1, S2, E1 and E2; and
the wireless circuits are configured to transmit at least the STA commit and confirm messages and receive at least the AP commit message.

14. The device of claim 9, wherein:
the wireless circuits are compatible with at least one IEEE 802.11 wireless standard;
the information data frame is selected from the group consisting of: a beacon and a probe response.

15. A system, comprising:
a station device (STA) that includes
controller circuits configured to
store at least a per device credential (PDC) that distinguishes the STA from other wireless devices,
exchange at least elements with an access point device (AP),
generate at least one encryption key with at least the elements,
compare an expected fingerprint to a system fingerprint,
transmit an association request to the AP that includes a hash of the PDC encrypted with the at least one encryption key, and
wireless circuits compatible with at least one IEEE 802.11 wireless standard; and
an antenna system coupled to the wireless circuits; wherein
the expected fingerprint comprises a result of a predetermined hashing operation executed on at least a portion of a service set identifier (SSID) of the AP and a public key corresponding to the AP (AP_K).

16. The system of claim 15, wherein the PDC is selected from the group of a device specific portion, and a device specific portion separated from the system fingerprint with at least one separation character.

17. The system of claim 15, wherein the SSID is selected from the group of an AP specific portion, and an AP specific portion separated from the system fingerprint with at least one separation character.

18. The system of claim 15, further including:
the AP configured to
store the hashes of PDCs for a plurality of different STAs,
exchange at least the elements with the STA,
generate at least one encryption key with at least the elements,
decrypt at least a portion of the association request to determine the presence of the hash of the PDC,
in response to the hash of the PDC matching one of the stored hashes of PDCs, transmitting an association response to the STA.

19. The system of claim 15, wherein the AP includes an access control list (ACL) configured to store at least the hashes of PDCs.

20. The system of claim 19, wherein the ACL is further configured to store public keys for a plurality of STAs having digital certificates.
